(19) United States
(12) Patent Application Publication
(10) Pub. No.: US 2007/0093221 A1
(43) Pub. Date: Apr. 26, 2007

(54) Audio muting circuit and audio muting method

(75) Inventor: Yasuhiro Kato, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/585,002

(22) Filed: Oct. 23, 2006

(30) Foreign Application Priority Data
Oct. 21, 2005 (JP) 2005-307383

(51) Int. Cl. H04B 1/16

(52) U.S. Cl. 455/194.1

(57) ABSTRACT

In an audio muting circuit, a mute signal generation circuit provides a mute signal in the form of a continuous pulsed signal at a predetermined frequency (48 kHz for example) higher than an audible frequency range (20 Hz to 20 kHz) for a predetermined period in which the mute signal is changed from “H” level which is an inactivation level to “L” level which is an activation level. Thus, an audio signal is also a continuous pulsed signal at the predetermined frequency higher than the audible frequency range. Accordingly, at the start of muting, “pop” noise is not heard by the human hear.

### BACKGROUND OF THE INVENTION

1. Field of the Invention

The present invention relates to an audio muting circuit and an audio muting method. In particular, the invention relates to an audio muting circuit and an audio muting method for muting an audio signal.

2. Description of the Background Art

An audio muting circuit provided in such audio-related equipment as a DVD (Digital Video Disc) player performs mute operation for silencing an audio output. A conventional audio muting circuit generates a short sharp “pop” noise (pop noise) at the start of muting.

FIG. 3 is a time chart showing waveforms of a mute signal of a conventional audio muting circuit and an audio signal appearing at an output terminal of the audio muting circuit. Referring to FIG. 3, in a silent state, the audio signal is at a potential of 0 V. At time t11, in response to fall of the mute signal from “H” level which is inactivation level to “L” level which is activation level, the potential of the audio signal becomes slightly higher than 0 V. Because of this, “pop” noise is generated at the start of muting.

Japanese Patent Laying-Open No. 2005-159871 for example discloses a configuration for reducing pop noise generated when an audio power amplifier is powered on and powered off. According to the publication, when the amplifier is powered on or powered off, a bias voltage is applied to the amplifier for allowing an output signal of the amplifier to be a signal at a frequency lower than an audible frequency range that cannot be reproduced by a reproducing speaker in a reproducing operation.

Further, Japanese Patent Laying-Open No. 2002-135155 discloses a method of preventing generation of noise at a receiver when a transmitter is powered off, without requiring a tone circuit and a tone detecting circuit. According to the publication, when a power switch of the transmitter is turned off, control means of the transmitter supplies a mute control pulse signal which is outside the audible frequency range to transmission means, and the mute control pulse signal is transmitted in the form of radio wave, while control means of the receiver detects the mute control pulse signal to operate a mute circuit.

Furthermore, Japanese Patent Laying-Open No. 05-014060 discloses a configuration including differential transistors of a pre-driver and a dummy pre-driver which is connected in parallel with the differential transistors, which has the same electrical constant and which receives no signal. In a standby or mute mode, the dummy transistor is used to form a closed loop and thereby balance input conditions of the differential transistors of the pre-driver. In this case, no pop noise is generated when power is supplied and when mute is made on/off.

Moreover, Japanese Utility Model Laying-Open No. 61-029522 discloses a muting circuit having a filter for the audible frequency range inserted in an acoustic transmission system in muting operation, so that muting operation is recognized in terms of audibility in reproduction.

As seen from the above, the conventional audio muting circuits have the problem that “pop” noise is generated at the start of muting.

### SUMMARY OF THE INVENTION

A chief object of the present invention is therefore to provide an audio muting circuit and an audio muting method that can reduce noise generated at the start of muting.

An audio muting circuit according to an aspect of the present invention is an audio muting circuit muting an audio signal, and including: a mute signal generation circuit outputting, in a normal mode, a mute signal at an inactivation level and outputting, in a mute mode, the mute signal at an activation level; an NPN bipolar transistor connected between an audio line where the audio signal is transmitted and a line of a reference potential; and a PNP bipolar transistor connected between a line of a power supply potential and a control electrode of the NPN bipolar transistor, rendered nonconductive when the mute signal is at the inactivation level, and rendered conductive when the mute signal is at the activation level. At start of muting, for a predetermined period in which the mute signal is changed from the inactivation level to the activation level, the mute signal generation circuit provides the mute signal in a form of a continuous pulsed signal at a predetermined frequency higher than an audible frequency range.

An audio muting circuit according to another aspect of the present invention is an audio muting circuit muting an audio signal, and including: a mute signal generation circuit outputting, in a normal mode, a mute signal at an inactivation level and outputting, in a mute mode, the mute signal at an activation level; and a first transistor connected between an audio line where the audio signal is transmitted and a line of a reference potential, rendered nonconductive when the mute signal is at the inactivation level and rendered conductive when the mute signal is at the activation level. At start of muting, for a predetermined period in which the mute signal is changed from the inactivation level to the activation level, the mute signal generation circuit provides the mute signal in a form of a continuous pulsed signal at a predetermined frequency higher than an audible frequency range.

Preferably, the audio muting circuit further includes a second transistor connected between a line of a power supply potential and a control electrode of the first transistor, rendered nonconductive when the mute signal is at the inactivation level and rendered conductive when the mute signal is at the activation level. The first transistor is rendered conductive in response to application of the power supply potential to the control electrode.

Still preferably, the predetermined frequency is 48 kHz.

An audio muting method according to the present invention is an audio muting method for muting an audio signal. A transistor is provided that is connected between an audio line where the audio signal is transmitted and a line of a reference potential, is rendered nonconductive when a mute signal is at an inactivation level and is rendered conductive when the mute signal is at an activation level. At start of muting, for a predetermined period in which the mute signal is changed from the inactivation level to the activation level, the mute signal is provided in a form of a continuous pulsed signal at a predetermined frequency higher than an audible frequency range.

In accordance with the present invention, for a predetermined period in which the mute signal is changed from the inactivation level to the activation level, the mute signal is provided in the form of a continuous pulsed signal having a predetermined frequency higher than the audible frequency range. Therefore, the audio signal is also provided in the form of a continuous pulsed signal having a predetermined frequency higher than the audible frequency range. In this way, noise generated at the start of muting can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit block diagram showing a schematic configuration of an audio muting circuit according to an embodiment of the present invention.

FIG. 2 is a time chart showing waveforms of a mute signal and an audio signal of the audio muting circuit as shown in FIG. 1.

FIG. 3 is a time chart showing waveforms of a mute signal and an audio signal of a conventional audio muting circuit.

### DESCRIPTION OF THE PREFERRED EMBODIMENTS

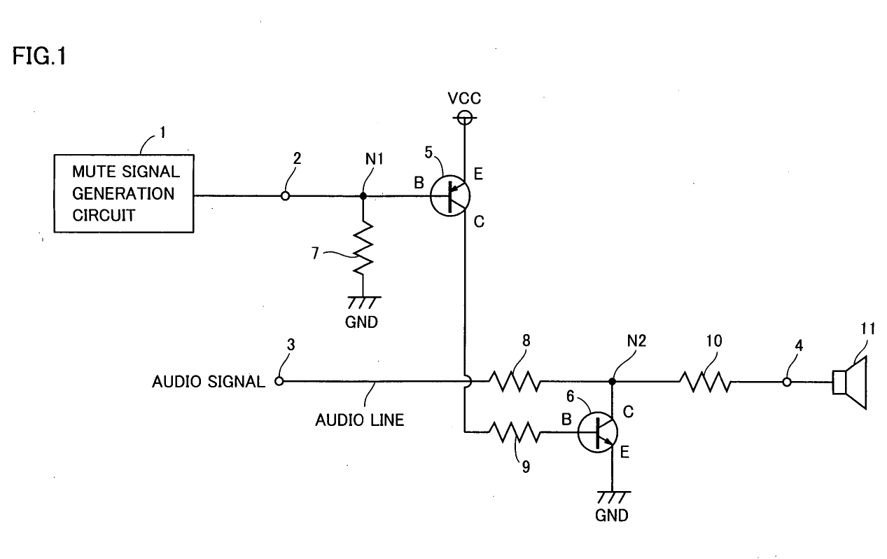

FIG. 1 is a circuit block diagram showing a schematic configuration of an audio muting circuit according to an embodiment of the present invention. Referring to FIG. 1, the audio muting circuit includes a mute signal generation circuit 1, a mute terminal 2, an input terminal 3, an output terminal 4, a PNP bipolar transistor 5, an NPN bipolar transistor 6, and resistor elements 7 to 10. Output terminal 4 is connected to a speaker 11.

An audio signal is supplied to input terminal 3, transmitted through an audio line and provided from output terminal 4 to speaker 11. Speaker 11 reproduces the audio signal provided from output terminal 4. Resistor element 8 and resistor element 10 are connected in series between input terminal 3 and output terminal 4. NPN bipolar transistor 6 is connected between a node N2 located between resistor element 8 and resistor element 10 and a line of a ground potential GND.

PNP bipolar transistor 5 and resistor element 9 are connected in series between a line of a power supply potential VCC (3.3 V for example) and base B of NPN bipolar transistor 6. Mute signal generation circuit 1 provides a mute signal at “H” level which is inactivation level or at “L” level which is activation level to mute terminal 2. Mute signal generation circuit 1 is incorporated for example in a microcomputer. The mute signal provided to mute terminal 2 is supplied to base B of PNP bipolar transistor 5. Resistor element 7 is connected between a node N1 located between mute terminal 2 and base B of PNP bipolar transistor 5 and a line of ground potential GND.

In a normal mode, mute signal generation circuit 1 supplies to mute terminal 2 the mute signal at “H” inactivation level. At this time, PNP bipolar transistor 5 and NPN bipolar transistor 6 are nonconductive so that the audio signal supplied to input terminal 3 is transmitted through the audio line and output from output terminal 4.

In a mute mode, mute signal generation circuit 1 supplies the mute signal of “L” activation level to mute terminal 2. At this time, PNP bipolar transistor 5 is rendered conductive so that electric current flows from the line of power supply potential VCC via PNP bipolar transistor 5 and resistor element 9 to base B of NPN bipolar transistor 6. Accordingly, NPN bipolar transistor is rendered conductive and the audio line is fixed to ground potential GND.

At this time, power supply potential VCC is applied via PNP bipolar transistor 5 and resistor element 9 to base B of NPN bipolar transistor 6, so that the audio line is raised to a potential slightly higher than ground potential GND. Thus, as shown in FIG. 3, the level of the audio signal becomes slightly higher than 0 V, resulting in the problem that “pop” noise is generated at the start of muting. Accordingly, in the present embodiment, such a problem is solved.

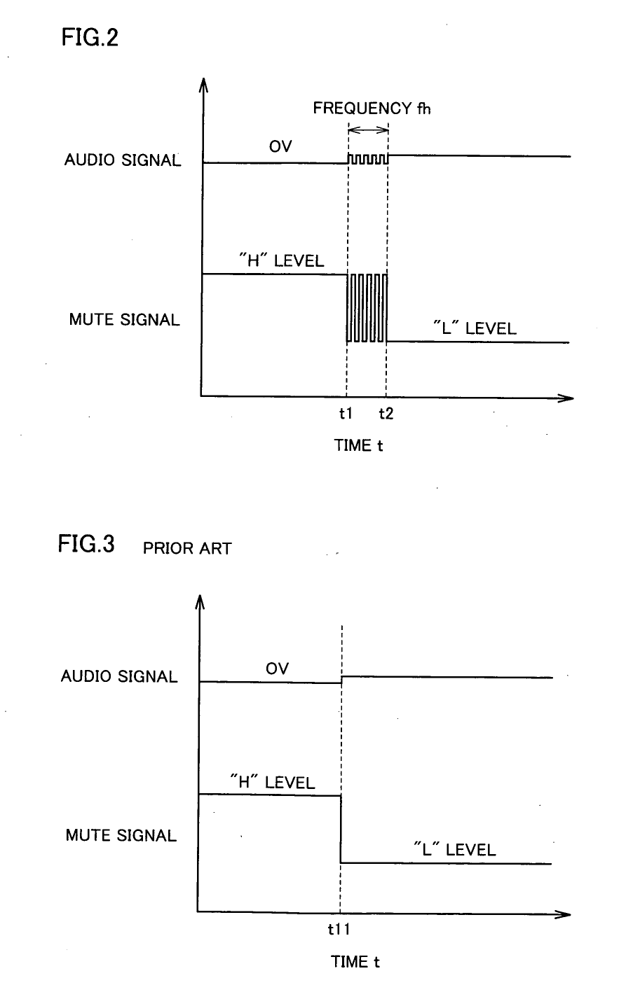

FIG. 2 is a time chart showing waveforms of a mute signal of the audio muting circuit as shown in FIG. 1 and an audio signal appearing at output terminal 4 of the audio muting circuit. Referring to FIG. 2, mute signal generation circuit 1 provides, for a predetermined period in which the mute signal is changed from “H” inactivation level to “L” activation level, namely the period from time t1 to time t2, the mute signal in the form of a continuous pulsed signal having a predetermined frequency fh (48 kHz for example) higher than an audible frequency range (20 Hz to 20 kHz). Therefore, in the period from time t1 to time t2, the audio signal is also in the form of a continuous pulsed signal having predetermined frequency fh higher than the audible frequency range. Accordingly, at the start of muting, “pop” noise cannot be heard by the human ear.

As seen from the above, according to the present embodiment, noise generated at the start of muting can be reduced. The audio muting circuit is applicable not only to the DVD player but also to various types of audio-related equipment such as DVD recorder and CD player.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An audio muting circuit muting an audio signal, comprising:
a mute signal generation circuit outputting, in a normal mode, a mute signal at an inactivation level and outputting, in a mute mode, the mute signal at an activation level;
an NPN bipolar transistor connected between an audio line where said audio signal is transmitted and a line of a reference potential; and
a PNP bipolar transistor connected between a line of a power supply potential and a control electrode of said NPN bipolar transistor, rendered nonconductive when said mute signal is at the inactivation level, and rendered conductive when said mute signal is at the activation level, wherein
at start of muting, for a predetermined period in which said mute signal is changed from the inactivation level to the activation level, said mute signal generation circuit provides said mute signal in a form of a continuous pulsed signal at a predetermined frequency higher than an audible frequency range.

2. An audio muting circuit muting an audio signal, comprising:
a mute signal generation circuit outputting, in a normal mode, a mute signal at an inactivation level and outputting, in a mute mode, the mute signal at an activation level; and
a first transistor connected between an audio line where said audio signal is transmitted and a line of a reference potential, rendered nonconductive when said mute signal is at the inactivation level and rendered conductive when said mute signal is at the activation level, wherein
at start of muting, for a predetermined period in which said mute signal is changed from the inactivation level to the activation level, said mute signal generation circuit provides said mute signal in a form of a continuous pulsed signal at a predetermined frequency higher than an audible frequency range.

3. The audio muting circuit according to claim 2, further comprising a second transistor connected between a line of a power supply potential and a control electrode of said first transistor, rendered nonconductive when said mute signal is at the inactivation level and rendered conductive when said mute signal is at the activation level, wherein
said first transistor is rendered conductive in response to application of said power supply potential to said control electrode.

4. The audio muting circuit according to claim 2, wherein said predetermined frequency is 48 kHz.

5. An audio muting method for muting an audio signal, wherein
a transistor is provided that is connected between an audio line where said audio signal is transmitted and a line of a reference potential, is rendered nonconductive when a mute signal is at an inactivation level and is rendered conductive when said mute signal is at an activation level, and
at start of muting, for a predetermined period in which said mute signal is changed from the inactivation level to the activation level, said mute signal is provided in a form of a continuous pulsed signal at a predetermined frequency higher than an audible frequency range.
